(19) United States
(12) Patent Application Publication
(10) Pub. No.: US 2025/0273708 A1
(43) Pub. Date: Aug. 28, 2025

(54) ELECTRODE-DECOUPLED REDOX FLOW BATTERY

(71) Applicant: Washington University, St. Louis, MO (US)

(72) Inventors: Shrihari Sankarasubramanian, St. Louis, MO (US); Jing Xie, St. Louis, MO (US); Vijay Ramani, St. Louis, MO (US)

(21) Appl. No.: 18/850,369

(22) PCT Filed: Apr. 5, 2023
(86) PCT No.: PCT/US23/17590

§ 371 Date: Sep. 24, 2024

Related U.S. Application Data
(60) Provisional application No. 63/363,028, filed on Apr. 15, 2022.

(51) Int. Cl. H01M 8/04186; H01M 4/96; H01M 8/1025; H01M 8/1051; H01M 8/18

(52) U.S. Cl. CPC H01M 8/04186; H01M 4/96; H01M 8/1025; H01M 8/1051; H01M 8/188; H01M 2300/0002

(57) ABSTRACT

A redox flow battery (RFB) is provided. The battery generally includes a catholyte including cerium ions, an anolyte including titanium ions, a porous cathode in contact with the catholyte, a porous anode in contact with the anolyte, and an ion exchange membrane positioned between the cathode and the anode, where the anode has a higher surface area than the cathode or the anode has a thickness greater than a thickness of the cathode, where the membrane is configured to restrict and/or prevent the passage of the cerium ions and/or the titanium ions and maintain ionic conductivity between the catholyte and the anolyte. A method for storing electricity and a method for generating an electrical current are also provided.

### CROSS-REFERENCE TO RELATED APPLICATIONS

This application claims priority to U.S. Provisional Application Ser. No. 63/363,028, filed on Apr. 15, 2022, the content of which is hereby incorporated by reference in its entirety.

### STATEMENT REGARDING FEDERALLY SPONSORED RESEARCH & DEVELOPMENT

This invention was made with government support under DE-AR0000768 awarded by the U.S. Department of Energy. The government has certain rights in the invention.

### BACKGROUND OF THE DISCLOSURE

The field of the disclosure relates generally to electrode-decoupled redox flow batteries, and more particularly, to titanium-cerium redox flow batteries.

Redox flow batteries (RFBs) are a promising technology for large scale energy storage due to the inherent decoupling of energy and power in the RFBs. For example, energy is stored and released by suitably changing the oxidation state of ions in solution (i.e., the electrolytes). As the electrolytes are pumped in from external reservoirs, the energy obtained from a given RFB cell or stack is a function of the reservoir size. The voltage of the stack is a function of the number of individual cells connected in series and is a function of the difference in equilibrium potential between the active species. Unlike batteries with solid electrodes, increasing the energy stored in a RFB does not require any changes in battery size or structure, as there is no impact on the current, and hence on the power output, of a RFB (i.e., decoupling of energy and power). This also has important cost implications relative to lithium ion batteries, because potentially doubling the capacity of a RFB only requires a doubling of the reservoir size and not duplication of the entire battery stack, which can be an expensive endeavor.

### BRIEF DESCRIPTION OF THE DISCLOSURE

In one aspect, disclosed herein is a redox flow battery (RFB). The battery generally includes: a catholyte including cerium ions, an anolyte including titanium ions, a porous cathode in contact with the catholyte, a porous anode in contact with the anolyte, and an ion exchange membrane positioned between the cathode and the anode, where the anode has a higher surface area than the cathode, or the anode has a thickness that is greater than a thickness of the cathode, where the membrane is configured to restrict and/or prevent the passage of the cerium ions and/or the titanium ions and maintain ionic conductivity between the catholyte and the anolyte.

In another aspect, disclosed herein is a method for storing electricity. The method generally includes preparing a catholyte that includes cerium ions; preparing an anolyte that includes titanium ions; placing a porous cathode in contact with the catholyte, placing a porous anode in contact with the anolyte, placing an ion exchange membrane between the cathode and the anode, where the anode has a higher surface area than the cathode or the anode has a thickness that is greater than a thickness of the cathode, where the membrane restricts and/or prevents the passage of the cerium and titanium ions and maintains ionic conductivity between the catholyte and the anolyte. In some aspects, the method for storing electricity generally includes preparing the redox flow battery as described elsewhere herein.

In another aspect, disclosed herein is a method for generating an electrical current. The method generally includes: preparing a redox flow battery, and flowing the catholyte and the anolyte at a flow rate along a surface of the ion exchange membrane thereby generating an electrical current; where the redox flow battery includes: a catholyte including cerium ions, an anolyte including titanium ions, a porous cathode in contact with the catholyte, a porous anode in contact with the anolyte, and an ion exchange membrane positioned between the cathode and the anode, where the anode has a higher surface area than the cathode or the anode has a thickness that is greater than a thickness of the cathode, where the membrane is configured to maintain ionic conductivity between the catholyte and the anolyte, and to allow the passage of anions and reduce or prevent the flow of cations.

### BRIEF DESCRIPTION OF THE DRAWINGS

FIG. 1 is a schematic of one aspect of an electrode-decoupled titanium-cerium redox flow battery.

FIG. 2 is a bar chart of Energy Efficiency (%) at Flow Rates (mL/min) as described in Example 1.

FIG. 3 is a bar chart of Energy Efficiency (%) and Average High Frequency Resistance (HFR) in mOhm for samples described in Example 2.

FIG. 4A is a voltammogram graph of current density J (mA/cm²) versus potential voltage E (V) versus Ag/AgCl for 0.9 M TiOSO₄ in 5.8 M CH₃SO₃H.

FIG. 4B is a voltammogram graph of current density J (mA/cm²) versus potential voltage E (V) versus Ag/AgCl for 0.9 M Ce(CH₃SO₃)₃ in 4 M CH₃SO₃H.

FIG. 4C is a voltammogram graph of current density J (mA/cm²) versus potential voltage E (V) versus Ag/AgCl for 0.5 M TiOSO₄ in 1.25 M H₂SO₄.

FIG. 4D is a voltammogram graph of current density J (mA/cm²) versus potential voltage E (V) versus Ag/AgCl for 0.25 M Ce₂(SO₄)₃ in 1 M H₂SO₄.

FIG. 5A is a graph of χ versus Scan Rate (V/s)^{0.5} for 0.9 M TiOSO₄ in 5.8 M CH₃SO₃H.

FIG. 5B is a graph of χ versus Scan Rate (V/s)^{0.5} for 0.9 M Ce(CH₃SO₃)₃ in 4 M CH₃SO₃H.

FIG. 5C is a graph of χ versus Scan Rate (V/s)^{0.5} for 0.5 M TiOSO₄ in 1.25 M H₂SO₄.

FIG. 5D is a graph of χ versus Scan Rate (V/s)^{0.5} for 0.25 M Ce₂(SO₄)₃ in 1 M H₂SO₄.

FIG. 6 is a bar chart of Energy Efficiency (%) for samples described in Example 4.

FIG. 7 is a bar chart of Energy Efficiency (%) for samples described in Example 5.

FIG. 8 is a bar chart of Energy Efficiency (%) for samples described in Example 5.

FIG. 9 is a bar chart of Energy Efficiency (%) for Sample 6A described in Example 6.

FIG. 10A is a graph of discharge curves, Discharge E (V) versus Normalized Discharge Capacity (%) for cell architectures described in Example 7.

FIG. 10B is a graph of cell level Efficiencies (%) over 100 Cycles for an optimized cell architecture described in Example 7. The graph shows Coulombic Efficiency, Voltage Efficiency and Energy Efficiency.

FIG. 11 is a plot of Energy Efficiency (%) for Run numbers 1-6 described in Example 7.

FIG. 12A is a graph of discharge curves, Discharge E (V) versus Normalized Discharge Capacity (%) for cell architectures described in Example 8.

FIG. 12B is a bar chart of cell level Efficiencies (%) and Average High Frequency Resistance (HFR) in mOhm for cell architectures described in Example 8. The chart shows Coulombic Efficiency (CE), Voltage Efficiency (VE) and Energy Efficiency (EE).

### DETAILED DESCRIPTION OF THE DISCLOSURE

In the following specification and the claims, reference will be made to a number of terms, which shall be defined to have the following meanings.

The singular forms “a”, “an”, and “the” include plural references unless the context clearly dictates otherwise.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed disclosure. The term “consisting essentially of” occupies a middle ground between “comprising” and “consisting of”.

Where a disclosure or a portion thereof is defined with an open-ended term such as “comprising,” it should be readily understood that (unless otherwise stated) the description should be interpreted to also describe such a disclosure using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Approximating language, as used herein throughout the specification and claims, may be applied to modify any quantitative representation that could permissibly vary without resulting in a change in the basic function to which it is related. Accordingly, a value modified by a term or terms, such as “about,” “substantially,” and “approximately,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The systems and methods described herein relate to an electrically rechargeable redox flow battery (RFB) with porous electrodes, a positive electrolyte or catholyte including dissolved cerium ions and a negative electrolyte or anolyte including dissolved titanium ions. The electrolytes and electrodes are separated by an ion exchange membrane, such as an anion exchange membrane (AEM), that prevents, or at least partially restricts, the crossover of the Ti or Ce ions while maintaining ionic conductivity by the free passage of suitable anions, such as sulfate or methanesulfonate (CH3SO3-). In many aspects, this results in an RFB which is stable for multiple charge and discharge cycles at different currents and voltages. The inventors discovered a Ti—Ce RFB cell configuration with overall performance improvement. The inventors surprisingly discovered that the optimized Ti—Ce RFB has increased operating power density and increased energy efficiency. The performance properties exhibited by the optimized RFB were unexpected as a battery's operating power density and its energy efficiency are typically, inversely correlated.

The RFB's use of earth abundant elements, as described herein, allows the RFBs to realize costs significantly lower than that of Li-ion batteries, and the construction of electrode-decoupled RFBs is a key step in this direction. Electrode-decoupled RFBs are hampered by the need to separate the cations. This issue was faced by NASA when they first tested the Fe—Cr RFB (L. H. Thaller, U.S. Pat. No. 3,996,064, 1976 and reports cited therein). A Fe—V system proposed by PNNL (Energy Environ. Sci., 2011, 4, 4068) also suffers from the same issue which they circumvent by using a mixed cation electrolyte, which has a significant impact on the performance of the RFB. Others have proposed V—Br, Br—S, Zn—Br, V—Ce, Fe—Br, Mn—Br, Ti—Mn, Fe—Ti systems. An extensive review of RFBs with both elemental and non-elemental actives may be found in Chem. Rev. 2015, 115, 11533-11558. Described herein is an RFB that overcomes and resolves many of the difficulties previously found in these systems. Thus, in one aspect, a Ti—Ce electrode-decoupled RFB is described herein. The following sections describe the electrolyte selection process, the specific economics of the Ti—Ce electrolytes compared to some common combinations in various stages of commercialization, and finally the RFB system and its performance.

In one aspect, disclosed herein is a redox flow battery (RFB). The battery generally includes: a catholyte including cerium ions, an anolyte including titanium ions, a porous cathode in contact with the catholyte, a porous anode in contact with the anolyte, and an ion exchange membrane positioned between the cathode and the anode, where 1) the anode has a higher surface area than the cathode or 2) the anode has a thickness that is greater than a thickness of the cathode, where the membrane is configured to restrict and/or prevent the passage of the cerium ions and/or the titanium ions and maintain ionic conductivity between the catholyte and the anolyte.

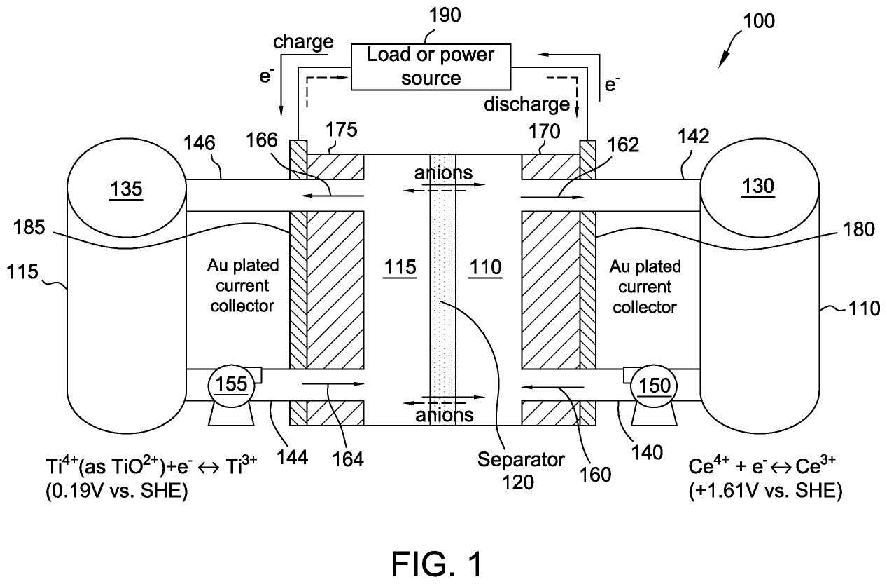

FIG. 1 shows a schematic of a redox flow battery 100 according to exemplary embodiments. The redox flow battery performs charging and discharging by supplying a positive electrolyte or catholyte 110 including cerium ions and a negative electrolyte or anolyte 115 including titanium ions through the redox flow battery 100. The redox flow battery 100 includes an ion exchange separator membrane, such as an anion exchange membrane (AEM) 120, positioned between the catholyte 110 and the anolyte 115. The separator AEM 120 prevents the passage of the cerium and titanium ions but allows anions to pass. The membrane 120 extends the entirety between the catholyte and the anolyte and separates the battery into two compartments or sections. The AEM separator membrane 120 restricts and/or prevents the passage of the cerium and titanium ions between the compartments but allows anions to pass through the membrane to maintain ionic conductivity between the catholyte and the anolyte.

The catholyte 110 is stored in an external tank 130 and the anolyte 115 is stored in an external tank 135. External tanks 130 and 135 are connected to the RFB 100 through conducting pipes 140, 142, 144 and 146. The catholyte 110 is pumped from external tank 130 through conducting pipe 140 into the RFB 100 by pump 150, as indicated by arrow 160. The catholyte 110 flows along the AEM 120 and through a porous positive electrode or cathode 170 contacting the surfaces of the cathode 170. The catholyte 110 circulates through conducting pipe 142 into the external tank 130, as indicated by arrow 162. The anolyte 115 is pumped from external tank 135 through conducting pipe 144 into the RFB 100 by pump 155, as indicated by arrow 164. The anolyte 115 flows along the AEM 120 and through a porous anode 175 contacting the surfaces of the anode 175. The anolyte 115 circulates through conducting pipe 146 into external tank 135, as indicated by arrow 166.

The catholyte 110 and the anolyte 115 undergo reduction-oxidation processes at the surfaces of the cathode 170 and anode 175, respectively. Electricity is generated and current required or produced is collected using current collectors 180 and 185, which are attached to a load or power source 190.

In one aspect, disclosed herein is a redox flow battery (RFB). A redox flow battery performs charging and discharging by supplying a catholyte and an anolyte to a battery cell including a cathode and an anode. The electrolytes utilize metal ions whose valences change as a result of oxidation-reduction. In some embodiments, the catholyte includes cerium ions, such as Ce⁴⁺ and Ce³⁺, and the anolyte includes titanium ions, such as Ti⁴⁺ and Ti³⁺ and as illustrated in the following two reduction potential reactions:

TiO²⁺→Ti³⁺+e− E°=+0.19 V

Ce⁴⁺→Ce³⁺+e− E°=1.61 V

In some aspects, the catholyte and the anolyte include acids or salts. In some aspects, the catholyte and the anolyte have at least one ion in common. In some aspects, the electrolytes include an electrochemically stable acid. As used herein, “electrochemically stable” means that a 1 M solution of the acid does not undergo a decomposition reaction at a voltage below 1.5V relative to a standard hydrogen electrode. In some aspects, both electrolyte solutions include acids. The acids may be the same or different. In some aspects, the acids may be sulfuric acid, sulfonic acid, perchloric acid, triflic acid, trifluoroacetic acid, acetic acid, formic acid, citric acid, phosphoric acid, or mixtures thereof.

In some embodiments, the catholyte and the anolyte may each independently include a sulfonic acid. In some embodiments, the catholyte and the anolyte each independently include a sulfonic acid, such as alkyl sulfonic acids, aryl sulfonic acids, methanesulfonic acid, ethanesulfonic acid, benzenesulfonic acid, o-toluenesulfonic acid, m-toluenesulfonic acid, p-toluenesulfonic acid, halogenated derivatives thereof, or combinations thereof. In some aspects, both the catholyte and the anolyte includes methanesulfonic acid.

In some embodiments, the sulfonic acid may be a halogenated sulfonic acid derivative. The halogenated sulfonic acid derivative includes at least one halogen atom (i.e., fluorine, chlorine, bromine, and iodine). In some embodiments, the halogenated sulfonic acid derivative includes at least two halogen atoms. In some embodiments, the halogenated sulfonic acid derivative includes at least three halogen atoms. In some embodiments, the halogenated sulfonic acid derivative is fully substituted by halogen atoms. In one embodiment, the halogenated sulfonic acid derivative is trifluoromethane sulfonic acid.

In some aspects, the electrolytes may include a salt, such as a sulfate. In one embodiment, the electrolyte solutions may include an ammonium sulfate or an iron sulfate. In one embodiment, the molar concentration of the salt in the catholyte or anolyte solutions is from about 1 M to about 6 M. In another embodiment, the molar concentration of the salt is from about 1 M to about 5 M. In another aspect, the molar concentration of the salt is from about 1 M to about 4 M. In another aspect, the molar concentration of the salt is from about 1 M to about 2 M. In some embodiments, the molar concentration of the acid in the catholyte and the anolyte are the same and in other embodiments, the molar concentrations are different. In one aspect, the catholyte and anolyte include ammonium sulfate in a molar concentration from about 1 M to about 2 M.

In some aspects, the electrolytes may include a supporting electrolyte. The supporting electrolyte may be an acid. In some aspects, the supporting electrolyte includes sulfuric acid, methane sulfonic acid, perchloric acid, triflic acid, benzene sulfonic acid, trifluoroacetic acid, acetic acid, formic acid, citric acid, phosphoric acid, or trifluoromethane sulfonic acid. In one embodiment, the electrolyte includes methanesulfonic acid and a supporting electrolyte. In another embodiment, the electrolyte may be methanesulfonic acid and a supporting electrolyte including sulfuric acid, perchloric acid, or a mixture of methanesulfonic acid and perchloric acid. In one embodiment, the ratio of the acid to the supporting electrolyte is from 1:99 to 99:1 and all increments in between.

In one embodiment, the molar concentration of the acid in the catholyte or anolyte solutions is from about 1 M to about 6 M. In another embodiment, the molar concentration of the acid is from about 1 M to about 5 M. In another aspect, the molar concentration of the acid is from about 1 M to about 4 M. In another aspect, the molar concentration of the acid is from about 1 M to about 2 M. In another embodiment, the molar concentration of the acid is from about 4 M to about 6 M. In another embodiment, the molar concentration of the acid is from about 2 M to about 4 M. In some embodiments, the molar concentration of the acid in the catholyte and the anolyte are the same and in other embodiments, the molar concentrations are different. In some embodiments, the catholyte and anolyte solutions include methanesulfonic acid and the molar concentration of methanesulfonic acid in the catholyte is less than or equal to the molar concentration of methanesulfonic acid in the anolyte. In one aspect, the catholyte includes methanesulfonic acid in a molar concentration from about 1 M to about 2 M and the anolyte includes methane sulfonic acid in a molar concentration from about 2 M to about 4 M.

In one embodiment, the molar concentration of the metal in the catholyte or anolyte solution is 5 M or less. In one embodiment, the molar concentration of the metal is from about 0.1 M to about 2 M. In another embodiment, the molar concentration of the metal in the catholyte or anolyte solution is from about 0.5 M to about 1.0 M. In one embodiment, the molar concentration of the metal in the catholyte or anolyte solution is about 0.9 M.

In some embodiments, the metal may be supersaturated or colloidal. In some aspects, the cerium solution is supersaturated with cerium. In some aspects, the cerium electrolyte is colloidal. For this aspect, high concentration Ce electrolytes where either Ce³⁺ salts or Ce⁴⁺ salts are allowed to partially precipitate but are kept suspended either by mechanical (e.g., stirring, ultrasonic agitation) or chemical means (e.g., surfactants (such as polyacrylic acid (US 2017/0298252)) to prevent agglomeration and settling). Depending on the concentration, a portion or all of the suspended particles re-dissolve and participate in the redox process as the concentration of the dissolved species of a particular oxidation state drops over the course of the redox process.

In some aspects, organic and inorganic additives are included to stabilize the supersaturated solutions of both oxidation states. The organic additives include, but are not limited to, malic acid, sorbitol, urea, glucose, fructose, inositol, phytic acid, EDTA, and organic compounds with 2 or more secondary or tertiary —SH or —NH₂ groups. The inorganic additives include, but are not limited to, phosphates, sulfates and methanesulfonates, such as, for example, potassium phosphate, sodium sulfate, ammonium sulfate, sodium pentapolyphosphate. Other additives that solubilize the cerium ion are known in the art and included herein.

The electrolytes are separated by an ion exchange membrane that prevents, or at least partially restricts, the crossover of the Ti or Ce ions while maintaining ionic conductivity between the electrolytes. The ion exchange membrane is positioned between the cathode and the anode and between the catholyte and the anolyte. The ion exchange membrane extends the entirety between the cathode and catholyte and the anode and anolyte to separate the battery into two compartments or sections. The separator membrane restricts and/or prevents the passage of the cerium and titanium ions between the compartments. The membrane allows ions to pass through the membrane to maintain ionic conductivity between the catholyte and the anolyte. The membrane is ionically conductive while simultaneously being electrically insulating.

In one embodiment, the ion exchange membrane has a thickness from about 10 μm to about 50 μm. In another embodiment, the separator membrane has a thickness from about 20 μm to about 40 μm. In one embodiment, the ion exchange membrane may be thin to lower the resistance of the membrane. In one embodiment, the membrane has a thickness from about 10 μm to about 30 μm. In another embodiment, the membrane has a thickness from about 15 μm to about 25 μm. In another embodiment, the membrane has a thickness from about 20 μm to about 30 μm. In another embodiment, the membrane has a thickness from about 20 μm to about 25 μm.

In one embodiment, the membrane may be reinforced with a reinforcement material base. The reinforcement material base may be a hydrophobic reinforcement matrix. The reinforcement material base may include polyethylene, polytetrafluoroethylene (PTFE), extended polytetrafluoroethylene (ePTFE), porous polypropylene or polyether ketone (PEK).

In some embodiments, the ion exchange membrane is characterized by the relative permeabilities of a cation and a counter anion. The flow cell battery exhibits improved performance when crossover of the cation is minimized but the counter anions freely cross over. In one embodiment, the ion exchange membrane is an anion exchange membrane (AEM), which reduces or prevents the passage of the titanium or cerium ions, but allows for the free movement of anions. Suitable anion membranes are described in U.S. Patent Application Pub. No. US 2021/0299650, which is incorporated herein by reference and in U.S. Patent Application Pub. No. US2022/013800, which is incorporated herein by reference. In one embodiment, the membrane includes quaternized cardo-poly(ether ketone), which is described in ChemPlusChem 2015, 80, 412-421. In some embodiments, the anion exchange membrane is selected from the group consisting of membranes comprising block copolymers, SEBS membranes, QPEK membranes, and combinations thereof.

In one embodiment, the ion exchange membrane may be a composite membrane and doped with one or more metal oxide fillers. The metal oxide fillers include, but are not limited to TiO₂, SiO₂, Al₂O₃, SnO₂, WO₂, SbO₂, NbO₂, and other transition metal oxides. In another embodiment, the membrane is an anion exchange membrane mixed with aluminum oxide particles.

In another embodiment, the membrane may be functionalized. In one embodiment, the membrane is functionalized with one or more cations, such as a trimethylamine cation.

In one embodiment, the membrane may be a reinforced composite anion exchange membrane including quaternized cardo-poly(ether ketone) functionalized with trimethylamine (TMA) cation. In another embodiment, the membrane may be a reinforced composite anion exchange membrane including quaternized cardo-poly(ether ketone) functionalized with trimethylamine (TMA) cation and mixed with aluminum oxide particles.

In some embodiments, the block co-polymer is a triblock co-polymer. In some embodiments, the triblock co-polymer comprises polystyrene-block-poly(ethylene-ran-butylene)-block-polystyrene (SEBS). In some embodiments, the SEBS triblock co-polymer is chloromethylated and functionalized with trimethylamine.

The redox flow battery includes electrically conductive porous electrodes. A porous cathode is in contact with the catholyte and a porous anode in contact with the anolyte. The electrodes are connected to an electrical source and promote electrolyte reduction-oxidation (REDOX) reactions on the surfaces of the electrodes. The current required or produced in the REDOX reactions is collected by current collectors, such as gold-plated copper current collectors. The electrodes may be carbon-based or mixed metal oxide and do not interact chemically with the electrolytes.

In one embodiment, the electrodes may be carbon-based. The carbon-based electrodes may be carbon felt pads, graphite foils, carbon paper or mixtures of materials. In one aspect, the cathode and the anode are individually carbon felt, carbon paper or mixtures of carbon felt and carbon paper.

In one embodiment, the carbon-based material may be compressed. In one embodiment, the carbon-based material may be compressed from about 10% to about 50%. In another embodiment, the carbon-based material may be compressed from about 10% to about 30%. In another embodiment, the carbon-based material is compressed from about 15% to about 25%. In one embodiment, the carbon-based material is compressed about 20%.

In another embodiment, the porous electrodes may be mixed metal oxide electrodes or dimensionally stable electrodes, which may include a titanium mesh.

The electrodes have a surface area suitable for promoting REDOX reactions or a thickness suitable for promoting REDOX reactions. In one embodiment, the electrodes have a thickness from about 100 μm to about 10 mm. In another embodiment, the electrodes have a thickness from about 150 μm to about 6.5 mm. In another embodiment, the electrodes have a thickness from about 100 μm to about 500 μm. In another embodiment, the electrodes have a thickness from about 300 μm to about 400 μm. In another embodiment, the electrodes have a thickness from about 4 mm to about 6 mm. In another embodiment, the electrodes have a thickness from about 4 mm to about 5 mm. In another embodiment, the electrodes have a thickness from about 4.5 mm to about 5 mm.

The electrodes may be pretreated to enhance the properties of the redox flow battery. In one embodiment, the electrodes may be pretreated with heat treatment, acid treatment, such as immersion in phosphoric acid or aqua regia or by surface coating.

In one aspect, the electrodes may be heat treated. In one embodiment, the electrodes may be heat treated from about 400° C. to about 600° C. In another embodiment, the electrodes may be heat treated from about 400° C. to about 500° C. In another embodiment, the electrodes may be heat treated from about 450° C. to about 500° C.

In one embodiment, the electrodes may be surface modified by coating the electrodes with a catalyst coating. The surface modification enhances the reaction kinetics of the electrolyte and suppress unwanted side reactions. In one embodiment, a metal catalyst is deposited on the surface of the electrodes. In this embodiment, the surface modification comprises a metal catalyst coating. In another embodiment, the electrodes may be coated by electrodeposition. In one embodiment, the electrodes may be coated with bismuth. In another embodiment, the electrodes may be coated with bismuth by electrodeposition.

In one embodiment, the porous electrode material may be arranged in flowfields, such as serpentine channels, and provide high surface area for the electrolyte REDOX reactions. In one embodiment, serpentine channels may be formed or machined into inert substrates, such as graphite plates. In one embodiment, the redox flow battery includes asymmetric electrodes. In one embodiment, the cathode comprises one or more layers of carbon paper. In one aspect, the cathode includes carbon paper and the anode includes carbon felt.

In one aspect, the anode has a higher surface area than the cathode. In one aspect, the cathode is thinner than the anode having a thickness that is less than a thickness of the anode. In one embodiment, the cathode has a thickness from about 100 μm to about 500 μm and the anode has a thickness from about 4 mm to about 6 mm.

In another embodiment, the cathode includes carbon paper and has a thickness from about 100 μm to about 500 μm and the anode includes carbon felt and has a thickness from about 4 mm to about 6 mm. In another aspect, the cathode is heat treated and the anode is heat treated and surface modified with a bismuth coating.

The electrolyte material may be stored in external reservoirs or tanks from which the electrolyte material is circulated through the RFB. The electrolyte material can have a tendency to precipitate, which can clog areas of the RFB, such as electrode flowfields. In one embodiment, any precipitated electrolyte material is maintained within the tanks and prevented from circulating through the RFB. Material may precipitate out of solution, falling to the bottom of the tanks or cling to the sides of the tank. Uptake pipes or tubes, such as the conducting pipes, may be positioned or adjusted to avoid the uptake of any settled or precipitated material within the tanks.

In another aspect, a method for storing electricity is provided. The method includes preparing a catholyte including cerium ions; preparing an anolyte including titanium ions; placing a porous cathode in contact with the catholyte, placing a porous anode in contact with the anolyte, and placing an ion exchange membrane between the cathode and the anode, where 1) the anode has a higher surface area than the cathode, or 2) the anode has a thickness that is greater than a thickness of the cathode. The membrane restricts and/or prevents the passage of the cerium and titanium ions and maintains ionic conductivity between the catholyte and the anolyte.

In some embodiments, energy is stored from a continuous power source, an intermittent power source, and combinations thereof.

In some embodiments, the continuous power source includes coal combustion, hydrocarbon combustion, nuclear power, hydroelectric power, geothermal power, and combinations thereof.

In some embodiments, the intermittent power source includes solar power, wind power, ocean wave power, tidal power, salinity gradient power, and combinations thereof.

In another aspect, a method for storing and a method for generating electricity is provided. A method for storing electricity generally includes preparing the redox flow battery. In one embodiment, the redox flow battery may be prepared by preparing a catholyte including cerium ions; preparing an anolyte including titanium ions; placing a porous cathode in contact with the catholyte, placing a porous anode in contact with the anolyte, and placing an ion exchange membrane between the cathode and the anode. The anode has a higher surface area than the cathode or has a thickness that is greater than a thickness of the cathode. The ion exchange membrane restricts and/or prevents the passage of the cerium and titanium ions and maintains ionic conductivity between the catholyte and the anolyte.

A method for generating an electrical current generally includes flowing the catholyte and the anolyte at a flow rate along a surface of the ion exchange membrane and through the porous electrodes to generate an electrical current.

The flow rate for the RFB may be any suitable flow rate for the pumping energy supplied for the battery. In one embodiment, an optimal flow rate is from about 100 mL/min to about 220 ml/min. In another embodiment, the optimal flow rate is from about 100 mL/min to about 150 ml/min.

### EXAMPLES

Ti—Ce redox flow batteries were improved and optimized. A Baseline Ti—Ce electrode-decoupled redox flow battery (ED-RFB) was prepared. The Baseline RFB has a cell configuration with a cathode and anode composed of a 20% compressed 6 mm carbon felt (CF), thermally treated at 450° C. and having a surface area of about 25 cm², a catholyte of 0.5 M Cerium (III) sulfate (Ce₂(SO₄)₃) in 1 M sulfuric acid (SA), an anolyte of 0.5 M Titanium (IV) oxysulfate (TiOSO₄) in 1.25 M SA and a separator composite membrane of quaternized cardo-polyetherketone functionalized with trimethylamine and mixed with Al₂O₃ particles.

The Ti—Ce RFB was assembled and cycled through 100 runs using a Scribner Inc., RFB test station. The electrolytes stored in external tanks were pumped using Cole-Parmer peristaltic pumps through the RFB where they were evenly distributed over and through the carbon felt through serpentine channels machined into the graphite plates. The electrolytes underwent redox processes when flowing through the carbon felt and the current required (or produced) was collected using gold plated copper current collectors.

### Example 1

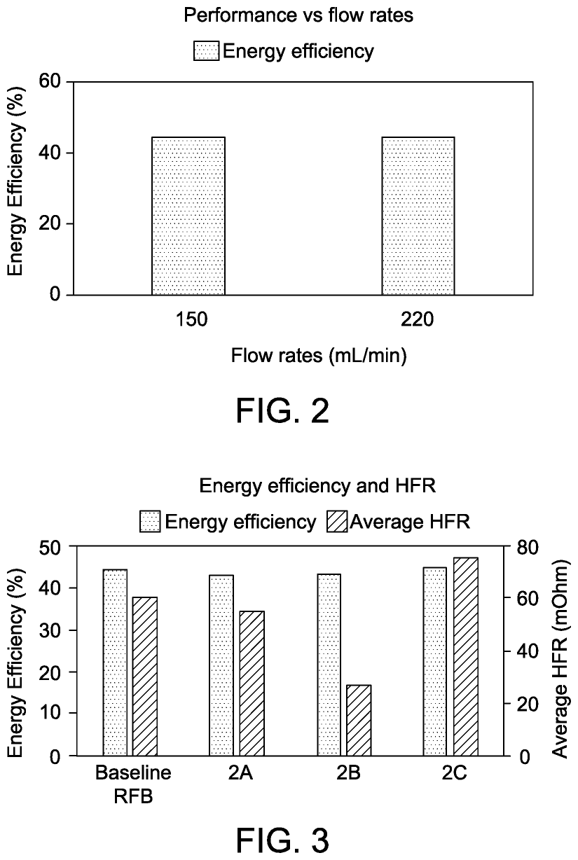

The effect of flow rate on the performance of the Baseline RFB was examined to identify an optimal flowrate for the baseline configuration. Results are shown in FIG. 2, which depicts a bar chart displaying the % energy efficiency (EE) of the Baseline RFB at 150 mL/min and 220 mL/min. The EE of the Baseline RFB at 150 mL/min was 44.3%. At a flow rate of 220 mL/min, the Baseline RFB capacity first decreased dramatically and then recovered. The energy efficiency for the Baseline RFB at 220 mL/min was about 45%. As the performance results were comparable, a flow rate of 150 mL/min was selected as the optimal flowrate to reduce pumping energy losses.

### Example 2

The effect of electrode thickness and heat treatment on the performance of the Baseline RFB was examined. The electrodes were systematically varied between carbon felt (CF), carbon paper (CP) and combinations of CF and CP. The Baseline RFB electrodes thermally treated at 450° C. were compared with electrodes heat treated at 500° C. Results are shown in FIG. 3, which depicts a bar chart displaying the % energy efficiency (EE) and average high frequency resistance (HFR) in mOhm for the electrode material for the Baseline RFB and Samples 2A, 2B and 2C.

Sample 2A is a Ti—Ce RFB having carbon felt (CF) electrodes heat treated at 500° C. The cell configuration has a cathode and an anode composed of a 20% compressed 6 mm carbon felt, thermally treated at 500° C., a catholyte of 0.5 M Cerium (III) sulfate (Ce₂(SO₄)₃) in 1 M sulfuric acid (SA), an anolyte of 0.5 M Titanium (IV) oxysulfate (TiOSO₄) in 1.25 M SA and a separator composite membrane of quaternized cardo-polyetherketone functionalized with trimethylamine and mixed with Al₂O₃ particles.

Sample 2B is a Ti—Ce RFB having carbon paper (CP) electrodes heat treated at 500° C. The cell configuration has both electrodes prepared from three layers of 20% compressed ˜150 μm CP, thermally treated at 500° C., a catholyte of 0.5 M Cerium (III) sulfate (Ce₂(SO₄)₃) in 1 M sulfuric acid (SA), an anolyte of 0.5 M Titanium (IV) oxysulfate (TiOSO₄) in 1.25 M SA and a separator composite membrane of quaternized cardo-polyetherketone functionalized with trimethylamine and mixed with Al₂O₃ particles.

Sample 2C is a Ti—Ce RFB having electrodes with P+CF+CP sandwich configuration. The cell configuration has both electrodes prepared from two 20% compressed layers of ˜150 μm CP and a 20% compressed layer of 6 mm carbon felt in a CP+CF+CP sandwich configuration, and thermally treated at 500° C., a catholyte of 0.5 M Cerium (III) sulfate (Ce₂(SO₄)₃) in 1 M sulfuric acid (SA), an anolyte of 0.5 M Titanium (IV) oxysulfate (TiOSO₄) in 1.25 M SA and a separator composite membrane of quaternized cardo-polyetherketone functionalized with trimethylamine and mixed with Al₂O₃ particles.

Each RFB was assembled and cycled through 100 runs using a Scribner Inc., RFB test station. The electrolytes stored in external tanks were pumped using Cole-Parmer peristaltic pumps through the RFB where they were evenly distributed over and through the carbon-based electrodes through serpentine channels machined into the graphite plates. The electrolytes underwent redox processes when flowing through the electrodes and the current required (or produced) was collected using gold plated copper current collectors. The flow rate for each RFB was 150 mL/min.

Comparable data was observed between thermal treatment at 450° C. and 500° C. The Baseline RFB with 20% compressed 6 mm CF electrodes thermally treated at 450° C. had an EE of 44.3% and an HFR of about 60 mOhm. Sample 2A had an EE of about 43% and an HFR of about 55 mOhm. These results were surprising as experimental reports for all-Vanadium RFBs showed improved performance in electrodes thermally treated at 500° C.

Sample 2B had an EE of about 43% and an HFR of about 28 mOhm. Despite the lower HFR in the 3×CP configuration, no improvements in EE were observed. Sample 2C had an EE of 44.8% and a very high HFR value of about 75 mOhm, which is unsuitable for the performance of the RFB. This result was very surprising, as the CP+CF+CP sandwich configuration thermally treated at 500° C. was found to significantly improve performance in an all-Vanadium RFB (Catalysis Today 370, 181-188 (2021)).

### Example 3

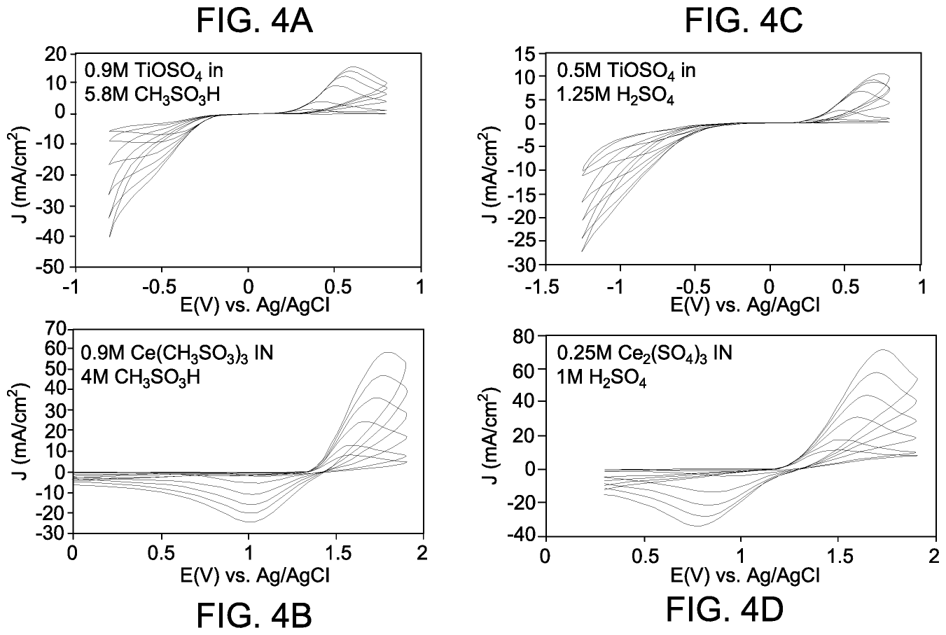

The electrochemistry of the Ti and Ce electrolytes was examined and the rate constants for the Ti and Ce redox reactions were determined. FIGS. 4A, 4B, 4C and 4D depict cyclic voltammograms of Ti—Ce ED-RFB electrolytes recorded at progressively increasing scan rates of 10, 25, 100, 225, 400 and 625 mV/s. FIG. 4A is a graph of current density J (mA/cm²) versus potential voltage E (V) versus Ag/AgCl for 0.9 M TiOSO₄ in 5.8 M CH₃SO₃H. FIG. 4B is a graph of current density J (mA/cm²) versus potential voltage E (V) versus Ag/AgCl for 0.9 M Ce(CH₃SO₃)₃ in 4 M CH₃SO₃H. FIG. 4C is a graph of current density J (mA/cm²) versus potential voltage E (V) versus Ag/AgCl for 0.5 M TiOSO₄ in 1.25 M H₂SO₄. FIG. 4D is a graph of current density J (mA/cm²) versus potential voltage E (V) versus Ag/AgCl for 0.25 M Ce₂(SO₄)₃ in 1 M H₂SO₄.

These voltammograms displayed the characteristic 30/a mV shift in the reduction peak position of the CV for a 10-fold increase in scan rate along with a greater than 59 mV difference between the reduction and oxidation peak potentials, indicating an irreversible reaction. Thus, the method proposed by Klingler and Kochi to measure the heterogenous rate constant from totally irreversible electrode processes was employed. The formal potentials were calculated from the cathodic and anodic peaks as (E_{form}=(E_{cathodic}+E_{anodic})/2) and used as an experimental proxy for the standard electrode potential (E⁰) when calculating the equilibrium rate constant (k₀) using the following equation:

$${k}_{0} exp [ \frac{β nF}{RT} ( {E}_{p} - {E}^{0} ) ] = {2.18 [ \frac{D β nF v}{RT} ]}^{( \frac{1}{2} )}$$

$$where χ = exp [ \frac{βnF}{RT} ( {E}_{p} - {E}^{0} ) ] .$$

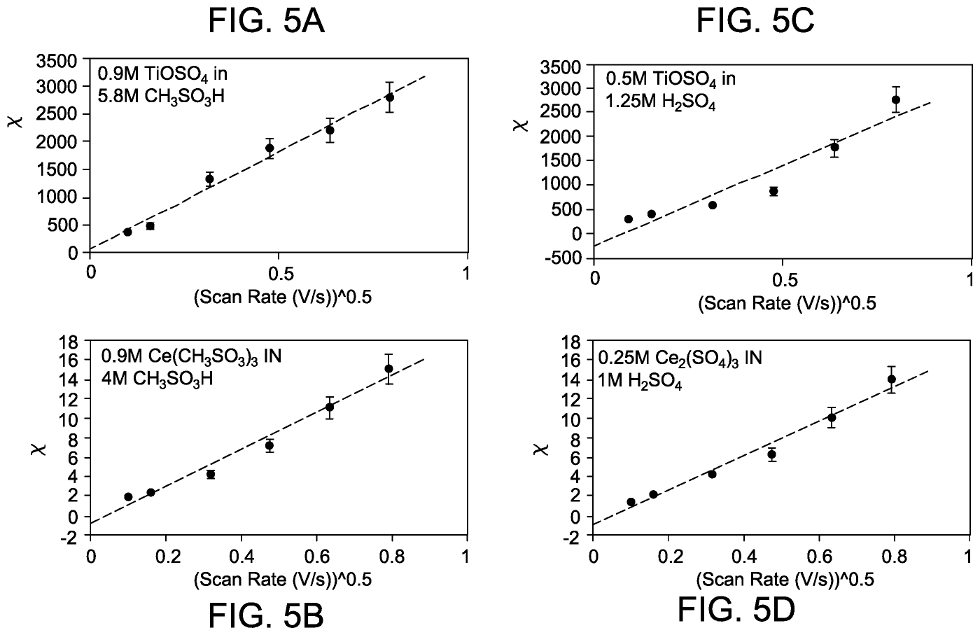

Thus, a plot of χ vs. v^{1/2} can be used to calculate the equilibrium constant k₀ (i.e., k at E=E⁰) from the slope. The plot of χ vs. v^{1/2} is depicted in FIGS. 5A, 5B, 5C and 5D. Error bars depict 10% standard error. FIG. 5A is a graph of χ versus Scan Rate (V/s)^{0.5} for 0.9 M TiOSO₄ in 5.8 M CH₃SO₃H. FIG. 5B is a graph of χ versus Scan Rate (V/s)^{0.5} for 0.9 M Ce(CH₃SO₃)₃ in 4 M CH₃SO₃H. FIG. 5C is a graph of χ versus Scan Rate (V/s)^{0.5} for 0.5 M TiOSO₄ in 1.25 M H₂SO₄. FIG. 5D is a graph of χ versus Scan Rate (V/s)^{0.5} for 0.25 M Ce₂(SO₄)₃ in 1 M H₂SO₄.

The calculated k₀ values in Ti and Ce electrolytes are listed in Table 1. The reactions measured correspond to the charge process of the Ti—Ce battery.

TABLE 1

| Electrolyte Composition | K₀ (×10⁻⁴ cm/s) |
|---|---|
| 0.5M TiOSO₄ in 1.25M H₂SO₄ | 2.33 ± 0.4 × 10⁻⁷ |
| 0.9M TiOSO₄ in 5.8M CH₃SO₃H | 4.34 ± 0.5 × 10⁻⁷ |
| 0.25M Ce₂(SO₄)₃ in 1M H₂SO₄ | 9.88 ± 1 × 10⁻⁴ |
| 0.9M Ce(CH₃SO₃)₃ in 4M CH₃SO₃H | 14.27 ± 1.3 × 10⁻⁴ |

The k₀ values indicate that the Ti³⁺/TiO²⁺ redox couple is significantly slower than the Ce³⁺/Ce⁴⁺ redox couple and CH₃SO₃H has a higher rate constant than H₂SO₄. Based on these differences, we decided to develop an asymmetric RFB cell with different electrode surface areas at the (Ti) anode and the (Ce) cathode. In addition, the RFB cell can be further optimized by using electrolytes with CH₃SO₃H and 0.9 M Titanium ions or 0.9 M Cerium ions.

### Example 4

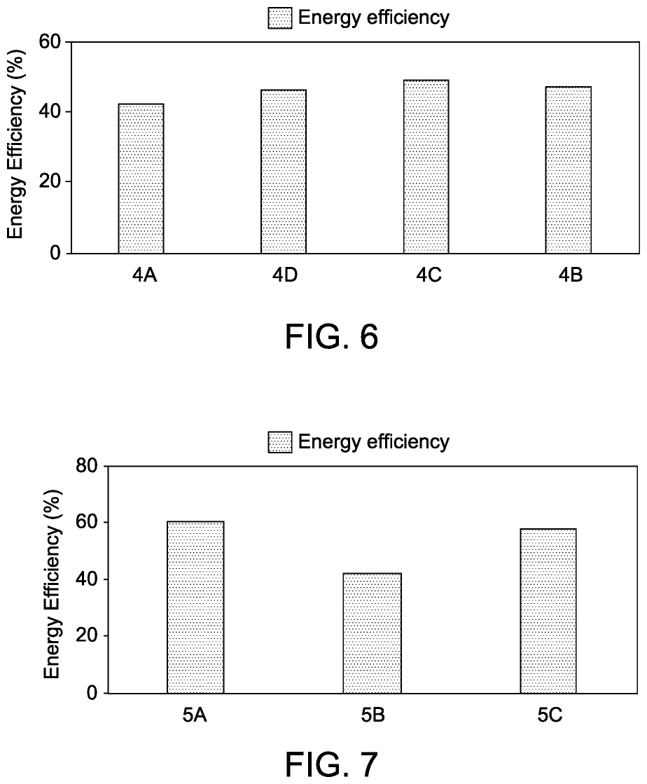

Electrode materials were examined and cell configurations for an asymmetric Ti—Ce RFB cell were identified. As the k₀ values in Table 1 were significantly lower for Ti, we decided to use carbon felt for the anodes on the Ti side and to lower the cell resistance by using thinner cathodes on the Ce side. The effect of varying the Ce cathode on performance of the RFB is shown in FIG. 6. FIG. 6 displays a bar chart showing the % energy efficiency (EE) for Samples 4A-4D with different Ce cathode configurations on CH₃SO₃H based Ti—Ce RFBs.

Sample 4A was prepared with methane sulfonic acid (MSA) electrolytes. The cell configuration has the anode and cathode composed of a 20% compressed 6 mm carbon felt, thermally treated at 450° C., a catholyte of 0.9 M Cerium (III) methanesulfonate (Ce(CH₃SO₃)₃) in 4 M MSA, an anolyte of 0.9 M Titanium (IV) oxysulfate (TiOSO₄) in 5.8 M MSA and a separator composite membrane of quaternized cardo-polyetherketone functionalized with trimethylamine and mixed with Al₂O₃ particles.

Sample 4B was prepared with asymmetric electrodes. The cell configuration has a cathode composed of a layer of 20% compressed ˜150 μm carbon paper (CP) and thermally treated at 500° C.; an anode composed of a 20% compressed 6 mm carbon felt (CF), thermally treated at 500° C., a catholyte of 0.9 M Cerium (III) methanesulfonate (Ce(CH₃SO₃)₃) in 4 M MSA, an anolyte of 0.9 M Titanium (IV) oxysulfate (TiOSO₄) in 5.8 M MSA and a separator composite membrane of quaternized cardo-polyetherketone functionalized with trimethylamine and mixed with Al₂O₃ particles.

Sample 4C was prepared with asymmetric electrodes. The cell configuration has a cathode composed of two layers of 20% compressed ˜150 μm carbon paper (CP) and thermally treated at 500° C.; an anode composed of a 20% compressed 6 mm carbon felt (CF), thermally treated at 500° C., a catholyte of 0.9 M Cerium (III) methanesulfonate (Ce(CH₃SO₃)₃) in 4 M MSA, an anolyte of 0.9 M Titanium (IV) oxysulfate (TiOSO₄) in 5.8 M MSA and a separator composite membrane of quaternized cardo-polyetherketone functionalized with trimethylamine and mixed with Al₂O₃ particles.

Sample 4D was prepared with asymmetric electrodes. The cell configuration has a cathode composed of three layers of 20% compressed ˜150 μm carbon paper (CP) and thermally treated at 500° C.; an anode composed of a 20% compressed 6 mm carbon felt (CF), thermally treated at 500° C., a catholyte of 0.9 M Cerium (III) methanesulfonate (Ce(CH₃SO₃)₃) in 4 M MSA, an anolyte of 0.9 M Titanium (IV) oxysulfate (TiOSO₄) in 5.8 M MSA and a separator composite membrane of quaternized cardo-polyetherketone functionalized with trimethylamine and mixed with Al₂O₃ particles.

Each RFB was assembled and cycled through 100 runs using a Scribner Inc., RFB test station. The electrolytes stored in external tanks were pumped using Cole-Parmer peristaltic pumps through the RFB where they were evenly distributed over and through the carbon-based electrodes through serpentine channels machined into the graphite plates. The electrolytes underwent redox processes when flowing through the electrodes and the current required (or produced) was collected using gold plated copper current collectors. The flow rate for each RFB was 150 mL/min.

Three asymmetric RFB configurations (Samples 4B, 4C and 4D) having a CF anode (20% compressed 6 mm carbon felt, thermally treated at 500° C.) and a thinner cathode prepared from carbon paper and thermally treated at 500° C. were examined and compared with a symmetrical RFB configuration (Sample 4A). Sample 4A had an EE of about 42%. Sample 4B had an EE of about 47%. Sample 4C had an EE of about 50% and Sample 4D had an EE of 46.3%. Each of the asymmetric samples, 4B, 4C and 4D, had higher energy efficiencies than the symmetrical sample 4A.

### Example 5

Lower molar concentrations of CH₃SO₃H (MSA) and supporting electrolytes for MSA were examined and the effect on RFB performance is shown in FIG. 7. FIG. 7 displays a bar chart showing the % energy efficiency (EE) for Samples 5A, 5B and 5C.

Sample 5A was prepared with a lower molar concentration of MSA. The cell configuration has a cathode composed of three layers of 20% compressed ˜150 μm carbon paper (CP) that was thermally treated at 500° C.; an anode composed of a 20% compressed 6 mm carbon felt (CF), thermally treated at 500° C., a catholyte of 0.9 M Cerium (III) methanesulfonate (Ce(CH₃SO₃)₃) in 2 M MSA, an anolyte of 0.9 M Titanium (IV) oxysulfate (TiOSO₄) in 2 M MSA and a separator composite membrane of quaternized cardo-polyetherketone functionalized with trimethylamine and mixed with Al₂O₃ particles.

Sample 5B was prepared with a supporting electrolyte. The cell configuration has a cathode composed of three layers of 20% compressed ˜150 μm carbon paper (CP) that was heat treated at 500° C., an anode composed of a 20% compressed 6 mm carbon felt, thermally treated at 500° C., a catholyte of 0.9 M Cerium (III) methanesulfonate (Ce(CH₃SO₃)₃) in 4 M MSA and sulfuric acid, an anolyte of 0.9 M Titanium (IV) oxysulfate (TiOSO₄) in 5.8 M MSA and sulfuric acid and a separator composite membrane of quaternized cardo-polyetherketone functionalized with trimethylamine and mixed with Al₂O₃ particles.

Sample 5C has a cell configuration with a cathode composed of three layers of 20% compressed ˜150 μm carbon paper (CP) that was heat treated at 500° C., an anode composed of a 20% compressed 6 mm carbon felt, thermally treated at 500° C., a catholyte of 0.9 M Cerium (III) methanesulfonate (Ce(CH₃SO₃)₃) in 4 M MSA and perchloric acid, an anolyte of 0.9 M Titanium (IV) oxysulfate (TiOSO₄) in 5.8 M MSA and perchloric acid and a separator composite membrane of quaternized cardo-polyetherketone functionalized with trimethylamine and mixed with Al₂O₃ particles.

Each RFB was assembled and cycled through 100 runs using a Scribner Inc., RFB test station. The electrolytes stored in external tanks were pumped using Cole-Parmer peristaltic pumps through the RFB where they were evenly distributed over and through the carbon-based electrodes through serpentine channels machined into the graphite plates. The electrolytes underwent redox processes when flowing through the electrodes and the current required (or produced) was collected using gold plated copper current collectors. The flow rate for each RFB was 150 mL/min.

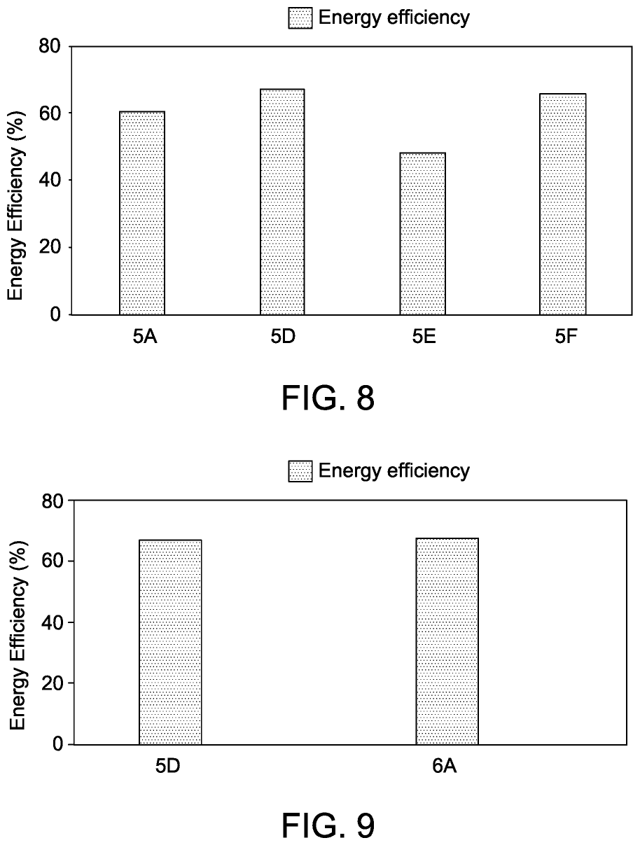

Sample 5A had an EE of 60.3%. Sample 5B had an EE of about 42% and Sample 5C had an EE of about 59%. Sample 5A has a 30% increase over Sample 4D shown in Example 4. As a result of this improvement, we varied the molar concentrations of similar lower MSA concentration RFB configurations with balanced anion concentrations and examined the performance of the RFBs in comparison with Sample 5A. The results are shown in FIG. 8. FIG. 8 displays a bar chart showing the % energy efficiency (EE) for Samples 5A, 5D, 5E and 5F.

The cell configuration for Sample 5D has a cathode composed of three layers of 20% compressed ˜150 μm carbon paper (CP) and thermally treated at 500° C., an anode composed of a 20% compressed 6 mm carbon felt (CF), thermally treated at 500° C., a catholyte of 0.9 M Cerium (III) methanesulfonate (Ce(CH₃SO₃)₃) in 2 M MSA, an anolyte of 0.9 M Titanium (IV) oxysulfate (TiOSO₄) in 3.8 M MSA and a separator composite membrane of quaternized cardo-polyetherketone functionalized with trimethylamine and mixed with Al₂O₃ particles.

The cell configuration for Sample 5E has a cathode composed of three layers of 20% compressed ˜150 μm carbon paper (CP) and thermally treated at 500° C., an anode composed of a 20% compressed 6 mm carbon felt (CF), thermally treated at 500° C., a catholyte of 0.9 M Cerium (III) methanesulfonate (Ce(CH₃SO₃)₃) in 1 M MSA, an anolyte of 0.9 M Titanium (IV) oxysulfate (TiOSO₄) in 2.8 M MSA and a separator composite membrane of quaternized cardo-polyetherketone functionalized with trimethylamine and mixed with Al₂O₃ particles.

Sample 5F was prepared with 1 M concentration of metal ions in the electrolyte solutions. The cell configuration has a cathode composed of three layers of 20% compressed ˜150 μm carbon paper (CP) and thermally treated at 500° C.; an anode composed of a 20% compressed 6 mm carbon felt (CF), thermally treated at 500° C., a catholyte of 1 M Cerium (III) methanesulfonate (Ce(CH₃SO₃)₃) in 2 M MSA, an anolyte of 1 M Titanium (IV) oxysulfate (TiOSO₄) in 4 M MSA and a separator composite membrane of quaternized cardo-polyetherketone functionalized with trimethylamine and mixed with Al₂O₃ particles.

Each RFB was assembled and cycled through 100 runs using a Scribner Inc., RFB test station. The electrolytes stored in external tanks were pumped using Cole-Parmer peristaltic pumps through the RFB where they were evenly distributed over and through the carbon-based electrodes through serpentine channels machined into the graphite plates. The electrolytes underwent redox processes when flowing through the electrodes and the current required (or produced) was collected using gold plated copper current collectors. The flow rate for each RFB was 150 mL/min.

Samples 5D, 5E and 5F have the same cell configuration as sample 5A except that the molar concentration amounts of the methane sulfonic acid (MSA) in the electrolyte solutions are varied and in sample 5F, the molar amount of the metal ions is also varied. In sample 5D, the anolyte includes 3.8 M MSA and the catholyte includes 2 M MSA and the EE was measured at 66.9%. In sample 5E, the anolyte includes 2.8 M MSA and the catholyte includes 1 M MSA and the EE was measured at about 46%. In sample 5F, the anolyte includes 1 M Titanium (IV) oxysulfate (TiOSO₄) in 4 M MSA and the catholyte includes 1 M Cerium (III) methanesulfonate (Ce(CH₃SO₃)₃) in 2 M MSA and the EE was measured at about 65%.

The best performance was obtained with sample 5D. This electrolyte composition reduces the amount of MSA needed by 40%. No advantage was observed by increasing the cation concentrations from 0.9M to 1M in sample 5F.

### Example 6

A thin separator was employed to reduce cell resistance and a metal catalyst was used to improve Ti redox kinetics. The effect on RFB performance was examined and the results are shown in FIG. 9. FIG. 9 displays a bar chart showing the % Energy Efficiency (EE) for Sample 6A in comparison with Sample 5D.

Sample 6A was prepared with a thin separator membrane and a metal catalyst added to an electrode. The cell configuration has a cathode composed of three layers of 20% compressed ˜150 μm carbon paper (CP) and thermally treated at 500° C.; an anode composed of a 20% compressed 6 mm carbon felt (CF), thermally treated at 500° C. and coated with about 30 μg/cm² of Bi electrodeposited on the electrode; a catholyte of 0.9 M Cerium (III) methanesulfonate (Ce(CH₃SO₃)₃) in 2 M MSA, an anolyte of 0.9 M Titanium (Titanium (IV) oxysulfate (TiOSO₄) in 3.8 M MSA and a reinforced separator of ˜26 μm that is composed of a composite quaternized cardo-polyetherketone functionalized with trimethylamine and mixed with Al₂O₃ particles and is reinforced with extended polytetrafluoroethylene (ePTFE).

The RFB was assembled and cycled through 100 runs using a Scribner Inc., RFB test station. The electrolytes stored in external tanks were pumped using Cole-Parmer peristaltic pumps through the RFB where they were evenly distributed over and through the carbon-based electrodes through serpentine channels machined into the graphite plates. The electrolytes underwent redox processes when flowing through the electrodes and the current required (or produced) was collected using gold plated copper current collectors. The flow rate for the RFB was 150 mL/min.

Sample 6A had an EE of 67.8% showing a slight performance increase over Sample 5D.

### Example 7

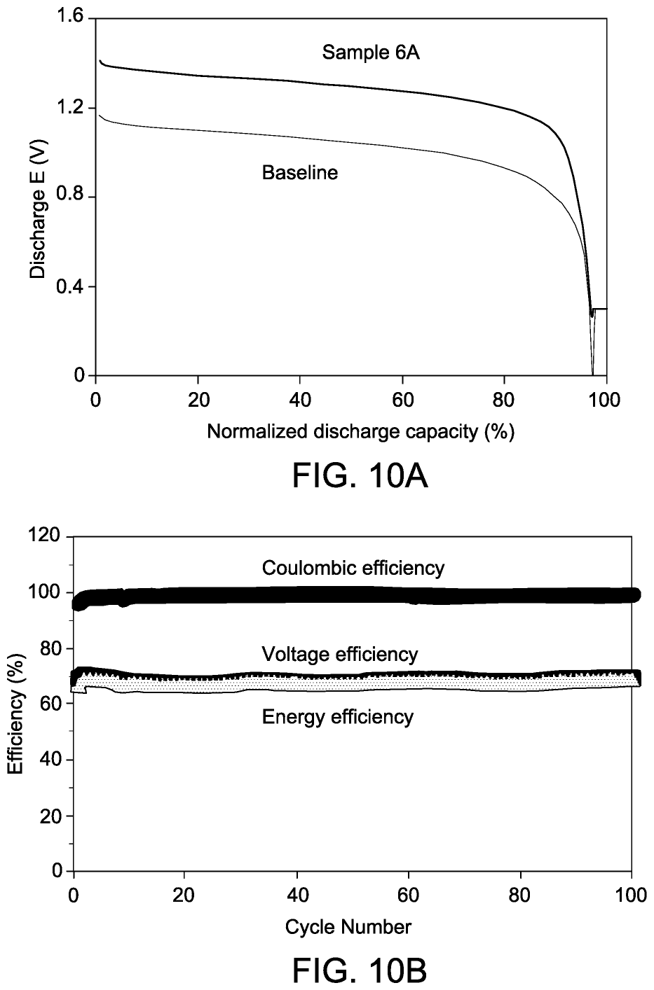

The performance of the Ti—Ce RFB configuration in Sample 6A is depicted in FIGS. 10A and 10B. FIG. 10A shows the discharge performance of the cell architecture of Sample 6A compared with the discharge performance of the Baseline RFB. FIG. 10B shows the cell level efficiencies of Coulombic Efficiency, Voltage Efficiency and Energy Efficiency for Sample 6A. No irreversible change in EE was observed over 100 cycles.

The power density for the Baseline RFB was determined to be 100 mW/cm² and the power density for Sample 6A was determined to be 175 mW/cm2. The EE for Sample 6A is 68±3.4% (based on ±0.2 A current accuracy of test stand) over 100 cycles. Sample 6A optimizes the Baseline RFB design increasing the power density by 75% and the EE by over 50%. These results in battery performance are surprising, because energy efficiency and power density are typically inversely correlated, and significant increases in both properties are unexpected.

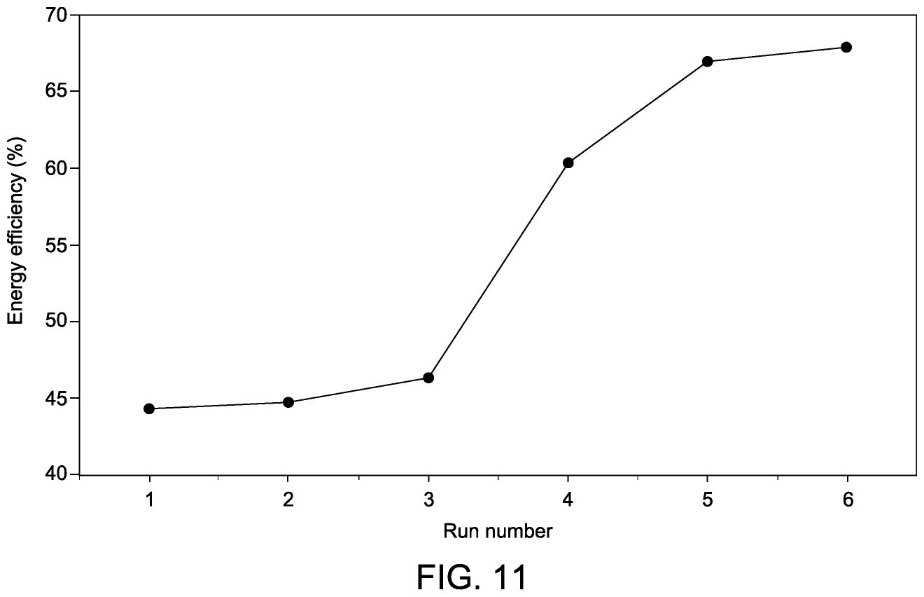

Improvements and optimization of RFB cell configurations are shown in Table 2 and FIG. 11. Comparative Baseline RFB Sample was prepared as described previously. Comparative Sample 2C was prepared and examined in Example 2. Sample 4D was prepared and examined in Example 4. Samples 5A and 5D were prepared and examined in Example 5. Sample 6A was prepared and examined in Example 6.

The abbreviation QPEK in Table 2 indicates a separator composite membrane of quaternized cardo-polyetherketone functionalized with trimethylamine and mixed with Al₂O₃ particles. The abbreviation Reinforced QPEK indicates a reinforced separator composite membrane of quaternized cardo-polyetherketone functionalized with trimethylamine and mixed with Al₂O₃ particles (QPEK), having a ˜26 μm thickness and reinforced with extended polytetrafluoroethylene (ePTFE).

TABLE 2

| RFB | | | | | | | Power |
|---|---|---|---|---|---|---|---|
| Sample | | | | | | EE | Density |
| (Run #) | Cathode | Catholyte | Anode | Anolyte | Membrane | (%) | (mW/cm²) |
| Baseline | CF heat | 0.5M | CF heat | 0.5M | QPEK | 44.3 | 100 |
| RFB | treated at | Ce(III) in | treated at | Ti(IV) in | | | |
| (Run 1) | 450° C. | 1M SA | 450° C. | 1.25M SA | | | |
| 2C | CP/CF/CP | 0.5M | CP/CF/CP | 0.5M | QPEK | 44.8 | |
| (Run 2) | heat | Ce(III) in | heat | Ti(IV) in | | | |
| | treated at | 1M SA | treated at | 1.25M SA | | | |
| | 500° C. | | 500° C. | | | | |
| 4D | CP/CP/CP | 0.9M | CF heat | 0.9M | QPEK | 46.3 | |
| (Run 3) | heat | Ce(III) in | treated at | Ti(IV) in | | | |
| | treated at | 4M MSA | 500° C. | 5.8M MSA | | | |
| | 500° C. | | | | | | |
| 5A | CP/CP/CP | 0.9M | CF heat | 0.9M | QPEK | 60.3 | |
| (Run 4) | heat | Ce(III) in | treated at | Ti(IV) in | | | |
| | treated at | 2M MSA | 500° C. | 2M MSA | | | |
| | 500° C. | | | | | | |
| 5D | CP/CP/CP | 0.9M | CF heat | 0.9M | QPEK | 66.9 | |
| (Run 5) | heat | Ce(III) in | treated at | Ti(IV) in | | | |
| | treated at | 2M MSA | 500° C. | 3.8M MSA | | | |
| | 500° C. | | | | | | |
| 6A | CP/CP/CP | 0.9M | CF heat | 0.9M | Reinforced | 67.8 | 175 |
| (Run 6) | heat | Ce(III) in | treated at | Ti(IV) in | QPEK | | |
| | treated at | 2M MSA | 500° C.; | 3.8M MSA | | | |
| | 500° C. | | Bismuth | | | | |
| | | | deposition | | | | |

The Ti—Ce RFB samples with asymmetric electrode configurations (Samples 4D, 5A, 5D and 6A) demonstrate improved battery performance. FIG. 11 shows the energy efficiency percent for RFB Sample Runs 1-6 and demonstrates the trajectory of improvement for RFB Sample Runs 3-6.

### Example 8

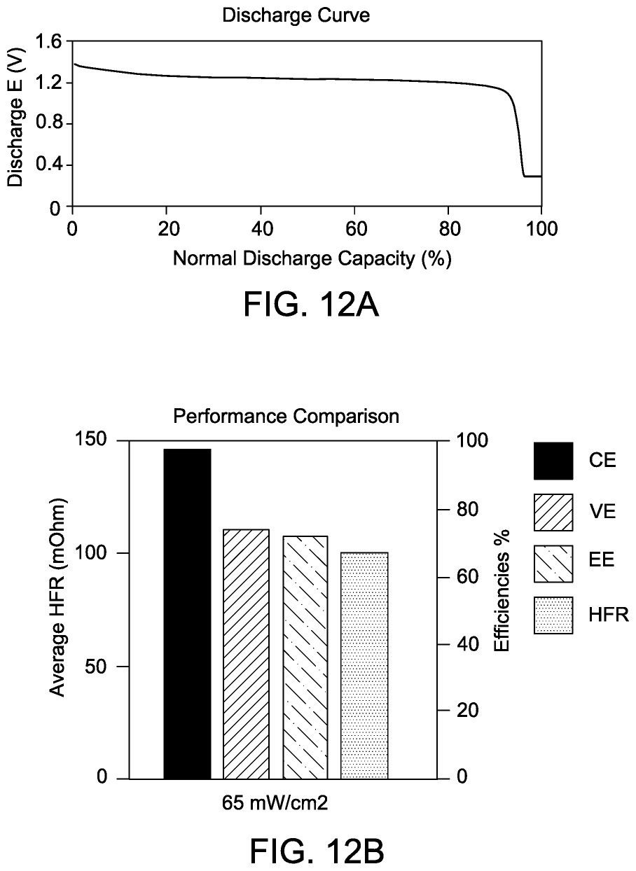

A Ti—Ce ED-RFB was prepared using ammonium sulfate for the electrolytes. The RFB performance results are shown in FIGS. 12A and 121B. FIG. 12A depicts a representative discharge profile (Discharge E (volts) versus Normalized Discharge Capacity) of the Ti—Ce ED-RFB. FIG. 12B depicts the cell level efficiencies of Coulombic Efficiency (CE), Voltage Efficiency (VE), Energy Efficiency (EE) and the average High Frequency Resistance (HFR) in mOhm for the Ti—Ce RFB cell.

The RFB cell configuration has a cathode composed of three layers of 20% compressed ˜150 μm carbon paper (CP) and thermally treated at 500° C.; an anode composed of a 20% compressed 6 mm carbon felt (CF), thermally treated at 500° C. and coated with about 30 μg/cm² of Bi electrodeposited on the electrode; a catholyte of 0.9 M Cerium (III) in 1.6 M ammonium sulfate, an anolyte of 0.9 M Titanium (Titanium (IV) oxysulfate (TiOSO₄) in 1.6 M ammonium sulfate and a reinforced separator of ˜26 μm that is composed of a composite quaternized cardo-polyetherketone functionalized with trimethylamine and mixed with Al₂O₃ particles and is reinforced with extended polytetrafluoroethylene (ePTFE).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A redox flow battery (RFB), the battery comprising:
a catholyte comprising cerium ions,
an anolyte comprising titanium ions,
a porous cathode in contact with the catholyte,
a porous anode in contact with the anolyte, and
an ion exchange membrane positioned between the cathode and the anode,
wherein the anode has a higher surface area than the cathode or the anode has a thickness that is greater than a thickness of the cathode,
wherein the membrane is configured to restrict and/or prevent the passage of the cerium ions and/or the titanium ions therethrough, and to maintain ionic conductivity between the catholyte and the anolyte.

2. The battery according to claim 1, wherein the cerium ions comprise Ce³⁺, Ce⁴⁺ or a mixture of Ce³⁺ and Ce⁴⁺ and the titanium ions comprise Ti⁴⁺, Ti³⁺ or a mixture of Ti⁴⁺ and Ti³⁺.

3. The battery according to claim 1, wherein the cathode and the anode are individually carbon felt, carbon paper or mixtures of carbon felt and carbon paper.

4. The battery according to claim 1, wherein the anode comprises carbon felt and the cathode comprises carbon felt, carbon paper or mixtures of carbon felt and carbon paper.

5. The battery according to claim 1, wherein one or both electrodes comprise a surface modification.

6. The battery according to claim 1, wherein the anode comprises a metal coating comprising bismuth.

7. The battery according to claim 1, wherein at least one of the electrolytes comprises an acid or salt.

8. The battery according to claim 1, wherein at least one of the electrolytes comprises an acid selected from the group consisting of sulfuric acid, methane sulfonic acid, perchloric acid, triflic acid, benzene sulfonic acid, trifluoroacetic acid, acetic acid, formic acid, citric acid, phosphoric acid, trifluoromethanesulfonic acid and mixtures thereof.

9. The battery according to claim 1, wherein both of the electrolytes comprise methanesulfonic acid or a mixture of methanesulfonic acid with either sulfuric acid or perchloric acid.

10. The battery according to claim 1, wherein both of the electrolytes comprise methanesulfonic acid in a molar concentration from about 1 M to about 6 M.

11. The battery according to claim 1, wherein the membrane comprises quaternized cardo-poly(etherketone).

12. The battery according to claim 1, wherein the membrane is a composite membrane comprising quaternized cardo-poly(etherketone) functionalized with trimethylamine and doped with one or more metal oxide fillers.

13. The battery according to claim 12, wherein the membrane is reinforced with a reinforcement material base.

14. The battery according to claim 12, wherein the one or more metal oxide fillers is selected from the group consisting of: TiO₂, SiO₂, Al₂O₃, SnO₂, WO₂, SbO₂, and NbO₂.

15. The battery according to claim 13, wherein the reinforcement material base is selected from the group consisting of: polyethylene, polytetrafluoroethylene, extended polytetrafluoroethylene, porous polypropylene, polyether ketone and combinations thereof.

16. The battery according to claim 1, wherein the membrane has a thickness from about 20 μm to about 30 μm.

17. The battery according to claim 1, wherein the redox flow battery further comprises electrolyte tanks from which the electrolyte material flows along a surface of the membrane, and wherein precipitates from either of the electrolytes are substantially confined to the electrolyte tanks.

18. The battery according to claim 1, wherein one or both electrolytes comprise ammonium sulfate or iron sulfate.

19. A method for storing electricity, the method comprising: preparing the redox flow battery according to claim 1.

20. A method for generating an electrical current, the method comprising: preparing the redox flow battery according to claim 1, and flowing the catholyte and the anolyte at a flow rate along a surface of the ion exchange membrane, thereby generating an electrical current.
